(19) United States
(12) Patent Application Publication
(10) Pub. No.: US 2026/0243153 A1
(43) Pub. Date: Aug. 20, 2026

(54) PROPPANT HANDLING SYSTEM WITH ONE OR MORE BUCKET ELEVATORS AND PROPPANT DELIVERY RATE CONTROL

(71) Applicant: Quickthree Technology, LLC, Yardley, PA (US)

(72) Inventors: William John Young, Newtown, PA (US); Ronald Whelan, Fort Collins, CO (US); Craig Luedtke, Hixton, WI (US)

(21) Appl. No.: 19/053,813

(22) Filed: Feb. 14, 2025

(51) Int. Cl. E21B 43/26; B65G 17/12; B65G 47/19; B65G 47/58; E21B 43/267

(52) U.S. Cl. CPC E21B 43/2607; E21B 43/267; B65G 17/126; B65G 47/19; B65G 47/58

(57) ABSTRACT

A system and method are disclosed for supplying proppant to a downstream process. The method includes delivering proppant through a discharge valve of a silo to a material conveyor that includes a belt for conveying the proppant to a system discharge. The belt may be operated at a constant rate. Weight measurements are collected from load cells that fully support the silo and any proppant contained therein. An actuator for the discharge valve is controlled based on the collected weight measurements over time to align an actual system proppant discharge rate (as determined from the weight measurements) to a desired system proppant discharge rate (as entered, for example, into a human machine interface in the system by a human system operator).

### FIELD OF THE INVENTION

This application relates to proppant handling and, more particularly, relates to proppant handling systems, typically located at or near the wellbore of a hydraulic fracturing (“fracking”) site, and that have a variety of proppant moving, handling, and storing equipment including one or more bucket elevators. It also relates to a highly accurate method of controlling proppant flow rate for supplying proppant to a downstream process by the system.

### BACKGROUND

Hydraulic fracturing (or fracking) refers to a well-stimulation technique that injects high-pressure fracking fluid into a wellbore to create cracks in deep-rock formations through which petroleum resources, such as oil or natural gas, can flow. Fracking fluid may vary in composition depending on a variety of considerations and the specific application to which the fracking fluid is to be applied. Fracking fluids, however, typically contain sand or some other proppant that is designed to keep any fractures produced by the fracking process open particularly after the fracking fluid has been withdrawn from the well.

Proppant for fracking is typically delivered to a well site (e.g., near the well head), stored temporarily at the work site, then, at an appropriate time, blended together with other components of the fracking fluid to form the end product to be injected into the wellbore.

Demand is high and growing for high capacity, high reliability, high accuracy (in flow rate), and easy-to-maintain proppant supplies to well-site fracking fluid blenders.

### SUMMARY OF THE INVENTION

In one aspect, a system includes a first material conveyor configured to receive a delivery of proppant and to convey the proppant to a discharge opening of the first material conveyor. A surge bin is configured to receive proppant from the discharge opening of the first material conveyor and to selectively discharge the proppant to a selected one of a plurality of surge bin discharge openings. A second material conveyor is configured to receive the proppant from a first one of the surge bin discharge openings and to convey the proppant to a discharge opening of the second material conveyor. A first bucket elevator is configured to receive the proppant from a second one of the surge bin discharge openings and to convey the proppant to a discharge of the first bucket elevator. A first silo is configured to receive the proppant from the discharge of the first bucket elevator and to discharge the proppant through a first silo discharge to the second material conveyor.

In a typical implementation, a valve controls a flow of proppant through the first silo discharge, and an actuator is coupled to the valve and configured to control a position (e.g., open, closed, somewhere in between) of the valve.

In a typical implementation, multiple load cells physically support an entirety of the first silo and any proppant contained within the first silo. Each of the load cells is configured to produce a time-varying signal (from either periodic or continuous load cell measurements) indicating the weight of the first silo and any proppant contained within the first silo.

In a typical implementation, a human-machine interface is configured to receive input information from a human operator setting a desired proppant delivery rate for the system to deliver into a downstream process.

In a typical implementation, a controller is configured to control the actuator based on the time varying signals from the plurality of load cells to maintain a flow of proppant from the first silo to the second material conveyor such that the system supplies proppant to the downstream process at the desired proppant delivery rate.

The second material conveyor typically is a belt conveyor operating at a constant speed.

In certain implementations, a second silo is configured to receive the proppant from the discharge of the first bucket elevator and to discharge the proppant onto the second material conveyor, and a first diverter valve coupled to the discharge of the first bucket elevator and configured to selectively divert proppant from the discharge of the first bucket elevator to either the first silo or the second silo.

In some such implementations, a second bucket elevator is configured to receive the proppant from a third one of the surge bin discharge openings and to convey the proppant to a discharge of the second bucket elevator. A third silo may be configured to receive the proppant from the discharge of the second bucket elevator and to discharge the proppant onto the second material conveyor. A fourth silo may be configured to receive the proppant from the discharge of the second bucket elevator and to discharge the proppant onto the second material conveyor. A second diverter valve may be coupled to the discharge of the second bucket elevator and configured to selectively divert proppant from the discharge of the second bucket elevator to either the third silo or the fourth silo.

The first silo may be configured to discharge the proppant onto the second material conveyor through a first silo discharge valve. The second silo may be configured to discharge the proppant onto the second material conveyor through a second silo discharge valve. The third silo may be configured to discharge the proppant onto the second material conveyor through a third silo discharge valve. The fourth silo may be configured to discharge the proppant onto the second material conveyor through a fourth silo discharge valve.

A typical implementation includes a plurality of load cells beneath, and fully supporting a weight of, each respective one of the first silo, the second silo, the third silo, and the fourth silo. Moreover, a typical implementation includes a plurality of actuators with each actuator being configured to control a respective one of the first silo discharge valve, the second silo discharge valve, the third silo discharge valve, and the fourth silo discharge valve.

The downstream process may be a blending process that utilizes a blender configured to blend the proppant supplied by the system to produce a fracking fluid. The blending process further utilizes a blender hopper configured to receive the proppant from a discharge of the second material conveyor.

In another aspect, a method includes delivering proppant through a discharge valve of a silo to a material conveyor that comprises a belt for conveying the proppant to a system discharge. The belt may be operated at a constant rate. The method includes collecting weight measurements from a plurality of load cells fully supporting the silo and any proppant contained therein. The method also includes controlling an actuator of the discharge valve based on the collected weight measurements over time to align an actual system proppant discharge rate determined from the weight measurements to a desired system proppant discharge rate as entered into a human machine interface by a human system operator.

In some implementations, one or more of the following advantages are present.

Highly accurate metering of proppant being supplied by the system to a downstream process can be achieved and be consistent with a desired proppant flow rate (e.g., one entered into the system at an HMI).

For example, the systems and techniques disclosed herein provide a high capacity, reliable, and readily available supply of proppant at a fracking wellsite. The systems and techniques typically include significant redundancy and are robust, yet flexible. Moreover, the systems are easy to maintain, relatively inexpensive and relatively straightforward to implement. Moreover, the amount of human support required to operate such systems tends to be less than prior approaches for making proppant available (e.g., to a fracking blender) at or near a fracking wellbore.

In a typical implementation, the system is configured such that a truck could be loading one type of proppant into one or more silos, while the system is providing a different type of proppant from a different one or more of the silos to the downstream blending process.

Other features and advantages will be apparent from the description and drawings, and from the claims.

### BRIEF DESCRIPTION OF THE DRAWINGS

FIG. 1A is a right side perspective view of an exemplary implementation of a system, in which the inventive systems and techniques disclosed herein are implemented.

FIG. 1B is a left side perspective view of the system in FIG. 1A.

FIG. 1C is a plan view of the system in FIG. 1A.

FIG. 1D is a right side elevation view of the system in FIG. 1A.

FIG. 1E is a front elevation view of the system in FIG. 1A.

FIG. 1F is a rear detailed view of a lower part of the system in FIG. 1A.

FIG. 1G is an alternative rear detailed view of a lower part of the system in FIG. 1A.

FIG. 1H is a front detailed view of a part of the system in FIG. 1A.

FIG. 1I is a rear detailed view of a lower part of the system in FIG. 1A.

FIG. 1J is a detailed right side perspective view of an upper part of the system in FIG. 1A.

FIG. 2 is schematic diagram showing an example of a proppant flow control system for the system of FIG. 1A.

FIG. 3 is a detailed schematic representation showing a portion of the belt feeder configuration in the system of FIG. 1A.

FIG. 4A is a front view of an exemplary implementation of a bucket elevator that may be used in the system of FIG. 1A.

FIG. 4B is a side view of the bucket elevator of FIG. 4A.

FIG. 4C is a perspective view of the bucket elevator in FIG. 4A.

FIGS. 4D and 4E are top views of the bucket elevator in FIG. 4A.

FIG. 5 is a partial side view of an alternative exemplary implementation of a bucket elevator in the system of FIG. 1A.

FIG. 6 is a schematic representation of the system of FIG. 1A delivering proppant into an exemplary downstream process.

Like reference characters refer to like elements.

### DETAILED DESCRIPTION

Hydraulic fracturing (or fracking) refers to a well stimulation technique that involves injecting high-pressure fracking fluid into a wellbore to create cracks in deep-rock formations through which petroleum resources, such as oil or natural gas, can flow. Fracking fluid may vary in composition depending on a variety of considerations and the specific application to which the fracking fluid is to be applied. Fracking fluids, however, typically contain sand or some other proppant that is designed to keep fractures produced by the fracking process open particularly after the fracking fluid has been withdrawn from the well. Proppant intended to support fracking activities may be delivered to a well site (e.g., near the well head) in trucks, stored temporarily at the work site, then, at an appropriate time, introduced into a blender for blending with other components to form a fracking fluid, which is injected into the wellbore. The demand is high and increasing for reliable, often continuous or almost continuous, supplies of proppant to blenders at well sites. In various implementations, the systems and techniques disclosed herein facilitate satisfying that high, growing and sometime variable demand for a reliable source of proppant. Moreover, the systems are comparatively simple and easy to maintain for the functionalities they provide. Various implementations of the systems disclosed herein provide for high capacity storage of proppant at a well head in a manner that facilitates fast delivery into a blender for that well head in a reliable manner. For onsite proppant storage, implementations of the systems disclosed herein include a blender hopper, a plurality of silos, a proppant storage container, as well as other system components that may contain smaller amounts of proppant during system operation—all on site, in close proximity to the blender and the well head.

Ensuring a readily available supply of proppant for an onsite blender hopper can be critical to successful fracking operations. This requires not only high capacity onsite storage capabilities, but also, traditionally, involves the cooperative effort of multiple skilled onsite workers. Various implementations of the systems and techniques disclose herein provide for unique approaches in automation that involve creative configurations of system components, sensors, control elements, etc. The advantages realized in this regard include a reduced need for onsite human support and may be provided through a robust, reliable, low maintenance, low cost, safe, and clean system configuration and configuration of system components.

It is important to note that proppant delivery times can sometimes be unreliable or irregular. As mentioned, trucks typically deliver proppant to well sites. Each truck may pull into the well site, deliver its load of proppant (e.g., via gravity dump or some other conveying technique) into a proppant receiver (e.g., a system, such as the SmartPath™ unloading system, available from Smart Sand, Inc., the applicant on the current application) configured to receive and temporarily store proppant at the wellsite, then drive off. In some implementations, the truck will drive over an opening in a housing of the proppant receiver, an operator may open a gate on the bottom of the truck to allow the proppant to feed into opening via gravity. In some implementations, the gate is opened fully to choke feed the sand into the opening in the housing of the proppant receiver. In that case, the unloading speed may be determined by the speed of the belt in the proppant receiver that is carrying the proppant away from the unloading station. The speed of the belt in the proppant receiver may be influenced by the status of the surge bin. More specifically, for example, if the surge bin is full (as indicated by a proppant level sensor in the surge bin), the belt in the proppant receiver stops. If, on the other hand, proppant is being drawn out of the surge bin (to the second material conveyor, and/or to either one (or both) of the bucket elevators), then the belt in the proppant receiver will speed up to replenish, maintain, or at least offset the loss of proppant in the surge bin. In an exemplary implementation, the belt in the proppant receiver is able to move at a speed that will provide proppant into the surge bin at a rate that is at least sufficient to maintain a level of proppant in the surge bin when proppant is being drawn out of the surge bin (to the second material conveyor, and/or to one or more of the bucket elevators) at the highest rate possible by the system. In cases where proppant is being choke fed into the opening in the housing of the proppant receiver, structural elements (e.g., walls, or tubes) may be provided to prevent any of the backed up proppant that is being choke fed into the opening in the housing of the proppant receiver from spilling out of the system.

In times of high demand or times when a system needs replenishing, it may be desirable that, as one emptied truck pulls away from the proppant receiver, another loaded truck pulls up immediately to the proppant receiver for a subsequent, almost immediate, second delivery. In good circumstances, this may continue, for example, with a relatively steady stream of trucks delivering, one after another, into the proppant receiver, particularly at a high demand well site. In fact, at very high demand well sites, it is not unusual for multiple trucks to be lined up, in a queue, ready to deliver their loads of proppant into the proppant unloading system at the well site, so that each truck can pulls in and dump its delivery as soon as the prior truck pulls away. This can help ensure a relatively steady and high rate of proppant delivery to the well site to help to satisfy a high demand for proppant in the well and the blender. That said, numerous obstacles can make it difficult for trucks to reach their intended well site destinations at desired times. These obstacles can include, for example, traffic conditions, mechanical failures, physical limitations of the drivers, challenges with loading trucks with proppant for delivery, and/or legal restrictions (restricting, e.g., where and when trucks might be allowed to drive). Implementations of the systems and techniques disclosed herein are particularly well suited for managing and adapting to circumstances that may arise due to a lack of sufficient or regular proppant deliveries via truck. These adaptations, as described herein, are largely automated and leverage the high local storage capacity available in a typical implementation of the systems described herein.

It is further desirable that proppant handling systems be robust and highly reliable. In a typical implementation, the proppant handling systems disclosed herein are just that—robust and highly reliable. They provide any one of several advantages while being easy to maintain, with certain sensors, for example, positioned away from the proppant moving through the system. As a result, the systems enjoy little unplanned downtime or interruptions, which, in such systems, particularly at busy well sites, can be very costly. The overall structure of each system component can be robust and reliable, which, especially if properly maintained, can help avoid or at least minimize unplanned downtime or interruptions and thereby further support the aim of the meeting the high and growing demand for proppant at well sites, and reduce maintenance efforts and cost.

Additionally, in a typical implementation, the systems and techniques disclosed herein may reduce overall operating costs (e.g., by eliminating the need for certain human operator interventions by automating certain aspects of system operation). Various functional aspects of the systems and techniques disclosed herein are automated to help ensure a high level of availability of proppant at the blender hopper regardless of circumstances and for relatively operating and maintenance costs. The systems disclosed herein are relatively simple in terms of construction and operation, which contributes to low cost and requirements for human operator intervention. System maintenance is also very straightforward and easy to do, when needed, which may be rare. Moreover, the systems may be deployed in a compact manner having an overall footprint that is small, particularly given the various functionalities, storage capacity, and operational and cost advantages of the system. Additionally, in a typical implementation, flow control through the system can be tightly controlled to help ensure that the primary proppant supply channel to the blender hopper is able to provide an adequate supply of proppant at all (or at least most) times to accommodate varying system demand. This may help ensure that any backup proppant supply sources (e.g., one or more silos adjacent the blender hopper) remain available, and to the fullest extent possible, so that most likely system demand can be satisfied even if the primary proppant source fails or becomes unavailable for a period of time. This increases overall system reliability, which is particularly important given the increasing, and varying over time, demand for proppant, and the resulting proppant slurry, at the well head and in the well bore, sites to support fracking operations. It also helps automate functionalities that may otherwise require a significant amount of monitoring and input from a human operator to ensure an appropriate degree of proppant flowing to the blender hopper. Many other advantages are possible.

Finally, implementations of the systems and techniques disclosed herein provide a unique and accurate control scheme for ensuring that the actual proppant delivery rate being supplied by the system matches a desired proppant delivery rate.

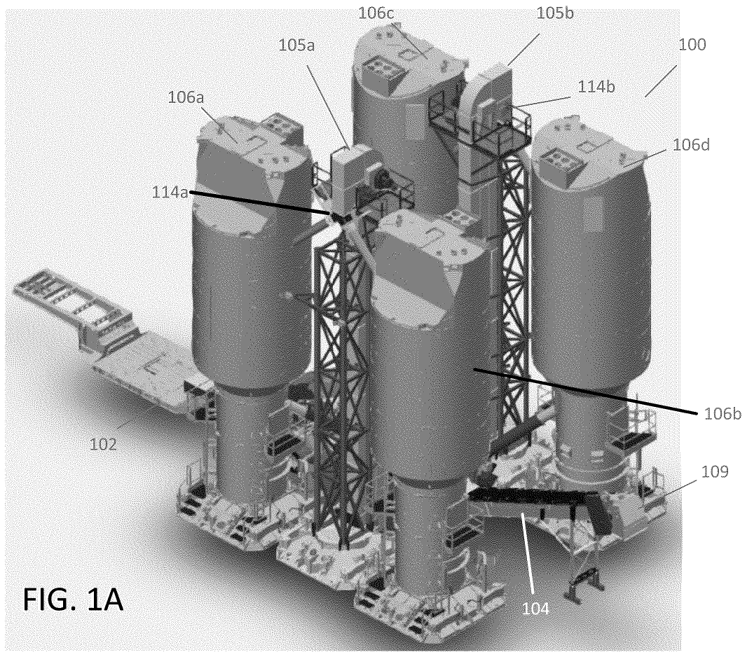

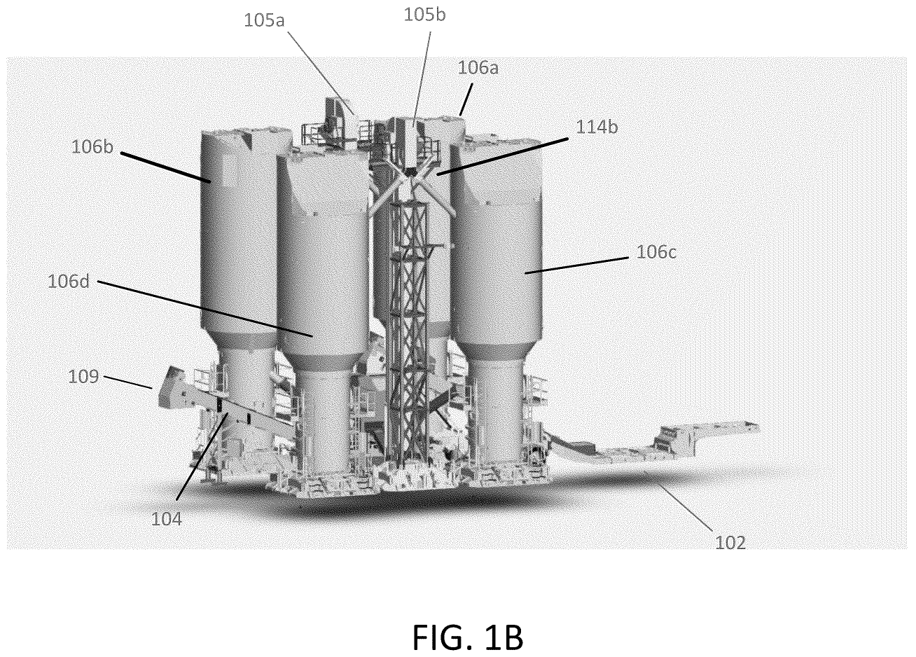

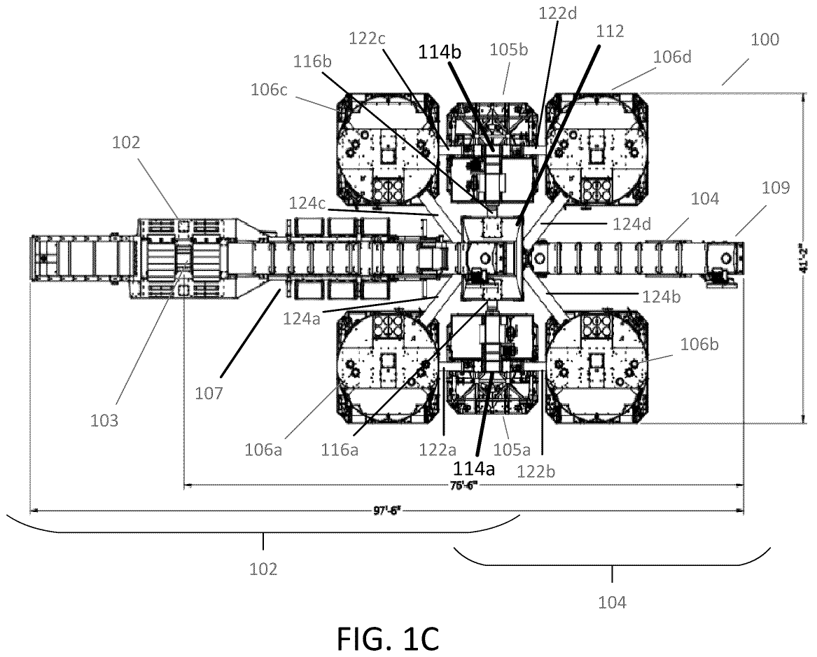

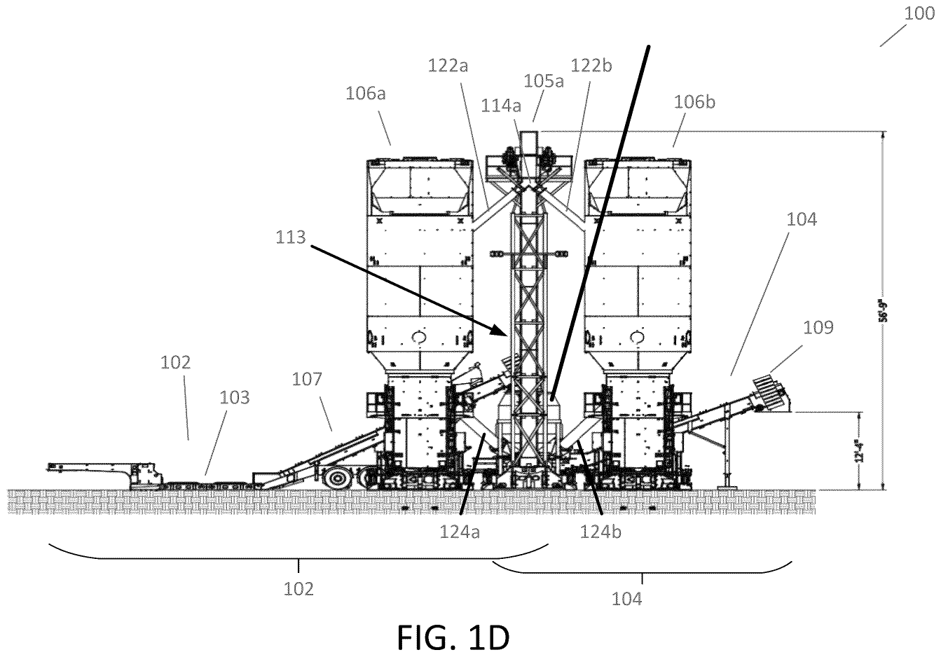

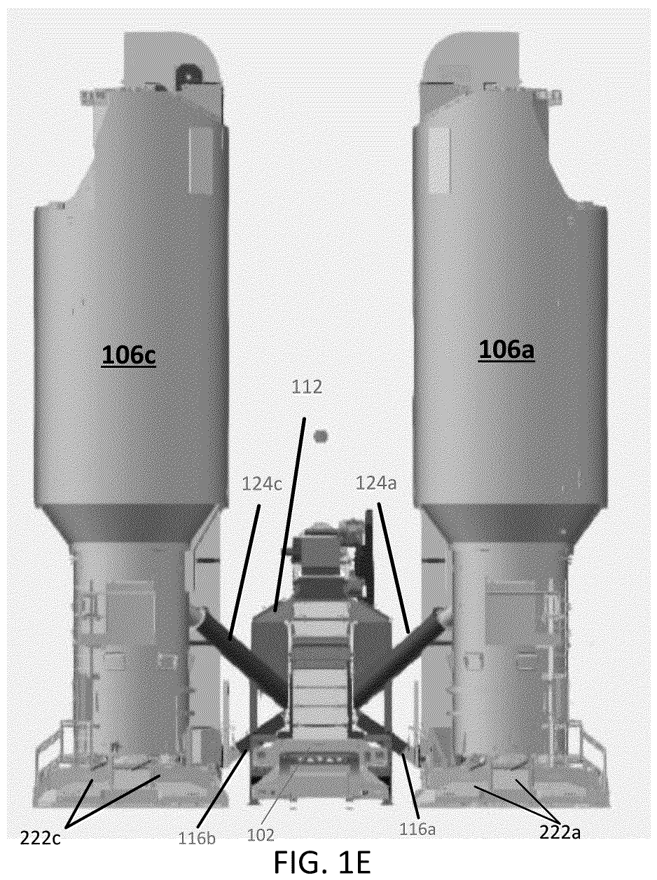

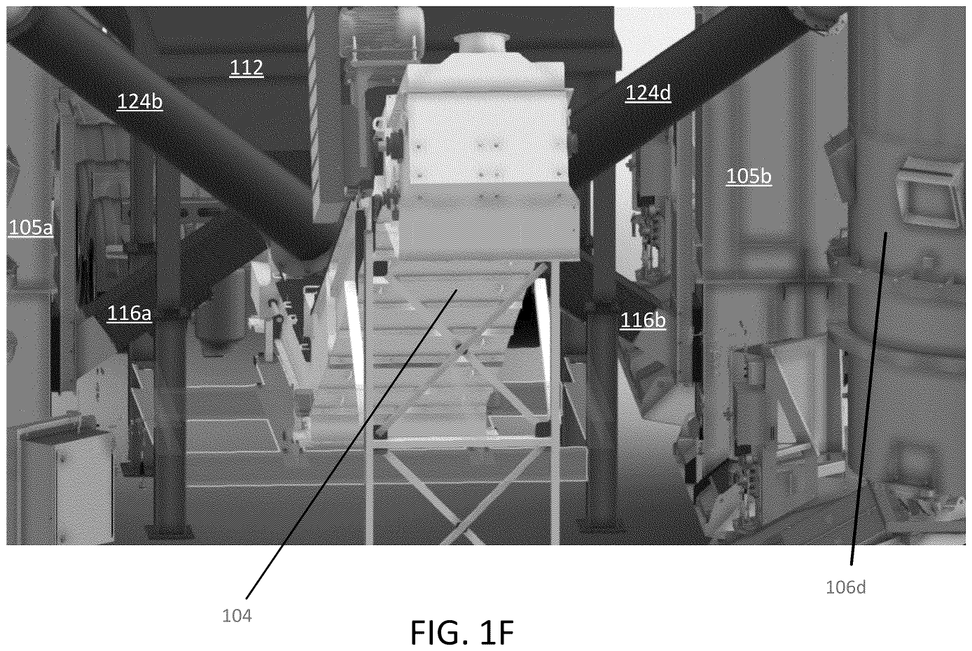

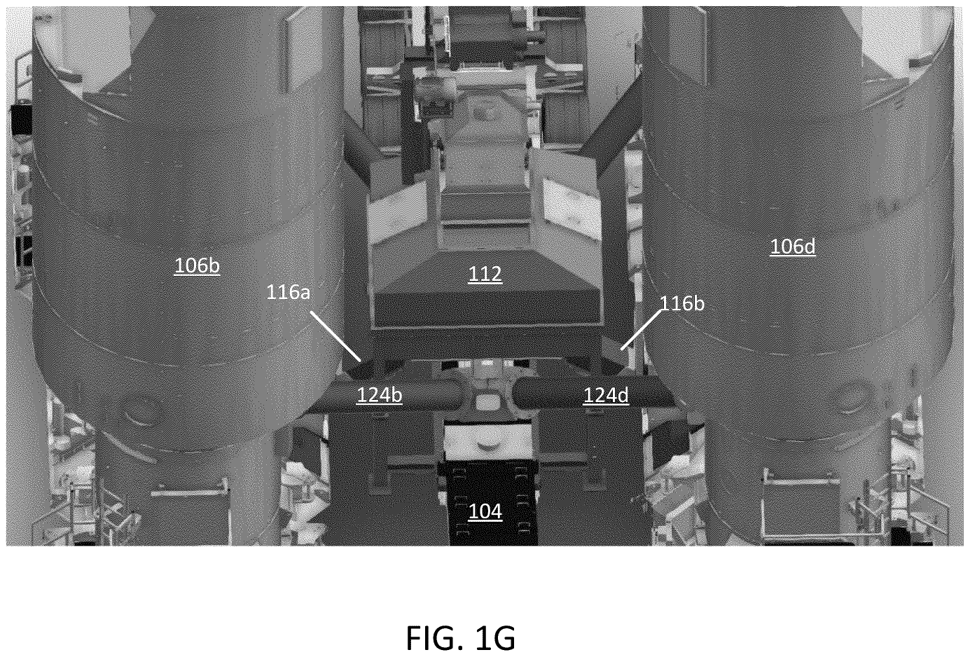

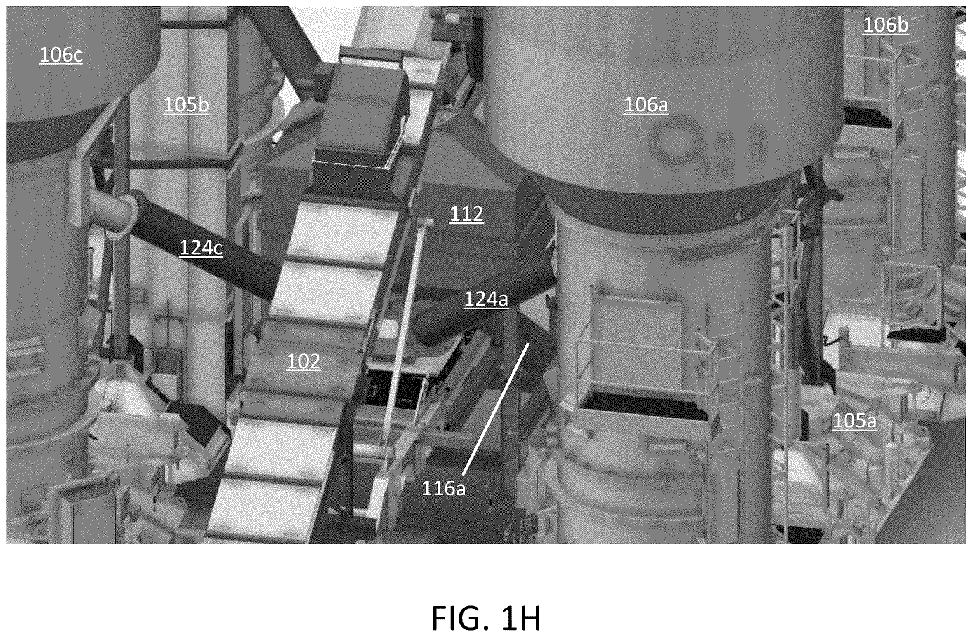

FIGS. 1A through 1J show an exemplary implementation of a system 100 for receiving and handling a delivery of proppant at a worksite. The system 100 has storage capacity for storing the proppant and is well configured to supply proppant into a blender unit or into a hopper for the blender unit (not shown). In a typical implementation, the blender unit would be configured to blend the proppant supplied by the illustrated system with one or more other liquid or solid components to form a blend (e.g., a solid-liquid slurry or “fracking fluid”) that can be delivered directly into the well bore, which would be proximate the blender unit.

Typically, the system 100 is deployed at the worksite, i.e., at, or in very close proximity to, the well head of a fracking well, so that the blend produced in the blender can be delivered promptly into the well bore, as needed, to meet the potentially high, and often varying, demand of the process at the well. The blender unit utilizes the proppant that is supplied by the system 100 to produce the blend, which may then be pressure injected (utilizing a pumping system) into the well bore to help enhance productivity at the well and support overall fracking operations.

The system 100 includes a proppant receiver 102 with a first conveyor 107, a proppant storage container 112 (or “surge bin”), a second conveyor 104, a pair of bucket elevators 105a, 105b, and four silos 106a-106d. In some implementations, the proppant receiver 102 may be integrated into and/or form at least a part of the SmartPath™ loading system, available from SmartSand, Inc. In some implementations, each of the silos may be a SmartDepot™ silo, also available from SmartSand, Inc. It should be made clear, of course, that the system 100 illustrated in FIGS. 1A through 1J is but one example of a system for receiving and handling proppant at a worksite. Numerous variations are possible. Indeed, any one or more of the individual components of the system 100 shown in FIGS. 1A through 1J could be replaced with a different component or combination of components that is physically different than the corresponding component or combination of components shown in FIGS. 1A through 1J but that performs substantially similar functionalities as the corresponding component(s) shown in FIGS. 1A through 1J. The components may be connected to one another in a variety of different ways. Likewise, the system and techniques disclosed herein may be advantageously deployed in any one of a variety of material handling applications including, for example, ones not specifically related to supplying proppant to support a fracking operation. Additionally, of course, the physical size, absolute and/or relative, and physical arrangement/positioning of the illustrated components and/or their functional equivalents may be varied as well.

In the illustrated system 100, the first conveyor 107 is configured to discharge into the surge bin 112, the surge bin 112 is configured to selectively discharge into the first bucket elevator 105a, the second bucket elevator 105b, the second conveyor 104, or some combination of two or more of those destinations. Each bucket elevator 105a, 105b is configured to selectively discharge into one or more of the silos 106a-106d. For example, bucket elevator 105a is configured to selectively discharge into one or more of silo 106a and silo 106b, which are adjacent to and on opposite sides of bucket elevator 105a. Similarly, bucket elevator 105b is configured to selectively discharge into one or more of silo 106c and silo 106d, which are adjacent to and on opposite sides of bucket elevator 105b. Each silo 106a-106d is configured to discharge into the second conveyor 104. The second conveyor 104 discharges to a system discharge, which, in a typical implementation, would be configured to discharge into a fracking blender or blender hopper at a fracking worksite.

The system 100 includes proppant flow passages, which may be in the form of tubes, pipes, chutes, or other types of flow channels, enclosed or otherwise, that facilitate and accommodate the flow of proppant between the different components of the illustrated system 100. In the illustrated implementation of system 100, for example, the discharge of the first conveyor 107 is directly connected to an inlet of the surge bin 112 to define an internal, enclosed flow channel 120 therebetween. The surge bin 112, in the illustrated system 100, is connected to the first bucket elevator 105a via a first bucket elevator chute 116a. Likewise, the surge bin 112, in the illustrated system 100, is connected to the second bucket elevator 105b via a second bucket elevator chute 116b. The surge bin 112, in the illustrated system 100, is connected to the second conveyor 104 via an internal, enclosed flow channel 118 therebetween. Bucket elevator 105a is connected to silo 106a via silo feed chute 122a. Likewise, bucket elevator 105a is connected to silo 106b via silo feed chute 122b. Similarly, bucket elevator 105b is connected to silo 106c via silo feed pipe 122c. Likewise, bucket elevator 105b is connected to silo 106d via silo feed pipe 122d. Each silo 106a-106d is connected to the second conveyor 104 via a corresponding flow passage. For example, in the illustrated implementation, silo 106a is connected to the second conveyor 104 via chute 124a, silo 106b is connected to the second conveyor 104 via chute 124b, silo 106c is connected to the second conveyor 104 via chute 124c, and silo 106d is connected to the second conveyor 104 via chute 124d. Moreover, in the illustrated implementation, two of the chutes 124a, 124c connect to the second conveyor 104 upstream of the connection (e.g., a gate) from the surge bin 112 into the second conveyor 104, and the other two chutes 124b, 124d connect to the second conveyor 104 downstream of the connection (e.g., a gate) from the surge bin 112 into the second conveyor 104.

In some instances, the system 100 may store different types of proppant in difference silos. For example, one of the silos (e.g., 106a) may store a first type of proppant (e.g., 40/70 mesh frac sand) whereas another one of the silos (e.g., 106d) may store a different, second type of proppant (e.g., 100 mesh frac sand). In those implementations, the first silo (e.g., 106a) may supply the first type of proppant (the 40/70 mesh frac sand) to the downstream process via the second conveyor 104, while the second type of proppant (e.g., 100 mesh frac sand) is being loaded from a delivery truck into the other silo (e.g., 106d).

In a typical implementation, the flow of proppant between certain system 100 components may be controlled by a valve that is configured to open and close so as to regulate the flow of proppant through the corresponding flow passage that connects those components. In a typical implementation, a controller is provided to control each valve (e.g., via a corresponding actuator), typically automatically, and typically in response to one or more controller inputs, which may include, for example, user commands (entered into a system control panel) and/or one or more signals from system sensors (configured to sense proppant levels, weights, etc. directly or indirectly in one or more containers (e.g., the surge bin 112, and/or any or all of the silos 106a-106d) within the system 100).

In a typical implementation, the flow of proppant from the first conveyor 107 to the surge bin 112 is unrestricted (i.e., there is no valve controlling proppant flow therebetween). Therefore, in a typical implementation, proppant simply falls off the distal end of a conveyor belt in the first conveyor 107 and drops, via gravity, through the discharge of the first conveyor, through flow channel 120, and into an inlet of the surge bin 112 without restriction or regulation.

In a typical implementation, a valve may be provided to control the flow of proppant from the surge bin 112 to each respective one of the first bucket elevator 105a, the second bucket elevator 105b, and the second conveyor 104. Depending on the configuration of those valves, in a typical implementation, the surge bin 112 may selectively discharge to any one, two, or all three of the first bucket elevator 105a, the second bucket elevator 105b, and the second conveyor 104, whichever is connected to a flow passage whose valve is in an open position.

In the illustrated system 100, there is a valve 114a, 114b at an upper end of each of the bucket elevators 105a, 105b. Each of those valves 114a, 114b may be configured to control the selective discharge of proppant from the upper end of each bucket elevator 105a, 105b into a corresponding one of the adjacent silos 106a-106d. In an exemplary implementation, each of these valves 114a, 114b is a route valve. In the illustrated implementation, for example, route valve 114a controls the selective discharge of proppant from the upper end of bucket elevator 105a to either silo 106a or silo 106b. Thus, depending on the configuration of the route valve 114a, proppant will be directed from the discharge at the upper end of the bucket elevator 105a to silo 106a or silo 106b. In some implementations, a valve configuration may be available that would enable the flow of proppant from the discharge of bucket elevator 105a to both silo 106a and silo 106b, simultaneously. Similarly, in the illustrated implementation, route valve 114b controls the selective discharge of proppant from the upper end of bucket elevator 105b to either silo 106c or silo 106d. Thus, depending on the configuration of the route valve 114b, proppant will be directed from the discharge at the upper end of the bucket elevator 105b to silo 106c or silo 106d. In some implementations, a valve configuration may be available that would enable the flow of proppant from the discharge of bucket elevator 105b to both silo 106c and silo 106d, simultaneously.

In some implementations, a discharge valve may be provided to control proppant discharge from each respective one of the silos 106a-106d, through a corresponding one of the silo feed pipes 122a-122d into the second conveyor 104.

The flow of proppant, from the second conveyor 104, in a typical implementation including the illustrated one, may be unrestricted (i.e., with no valve controlling proppant flow from the second conveyor 104 to any downstream process, e.g., a blender unit or a blender hopper for a blender unit). In a typical implementation, therefore, the second conveyor 104 discharges freely (e.g., in an unobstructed manner) to the downstream process.

At a high level, the illustrated system 100 is configured to receive proppant deliveries, store large quantities of the delivered proppant in its containers (typically, in close proximity to the worksite where the proppant can be put to practical use in a downstream application such as a fracking operation), and making the stored proppant, regardless of quantity, available for introduction into the downstream application, virtually immediately.

The deliveries typically arrive via truck and are introduced into the system 100 by bottom dumping the proppant from the truck through an opening in the housing of the proppant receiver and onto the first material conveyor 107. The deliveries can be made at virtually any time interval and with virtually any degree of regularity. In some instances, deliveries may be made at a very high rate of delivery and very regularly, with a sequence of delivery trucks driving one at a time over the proppant receiver (on a set of ramps), bottom dumping their payloads (or proppant) onto the first material conveyor 107 and immediately driving off, followed almost immediately thereafter by the next truck doing the same thing. The system 100 in such situations is able to effectively convey the delivered proppant for storage into any one or more (or all) of the silos 106a-106d and in the surge bin 112.

The illustrated system 100 is also configured to deliver proppant to the downstream process at almost any rate to accommodate demand by the process, which may, at times, be quite high, and which may vary considerably over time. Specifically, the system 100 is configured to deliver stored proppant from any one or more of the silos 106a-106d and/or the surge bin 112 to the downstream process view the second conveyor 104.

It is not unusual for the rate of delivery of proppant into the system 100 to differ from the rate of delivery of proppant by the system 100 into the downstream process. The system 100 is especially well suited to accommodate short term mismatches between proppant delivery rate into the system 100 and proppant delivery rate to the downstream process, which is based on process demand. The system 100 typically accommodates such differences without interrupting the delivery of proppant into the system 100 or the delivery of proppant by the system 100 into the downstream process.

The system 100 requires little in terms of set up, operation, and/or maintenance. Therefore, the workforce required and associated cost to support system 100 set-up, operation, and maintenance is low. The system 100 is robust in design and, typically construction, and has multiple contingencies built into it. Therefore, the likelihood of a complete system shutdown or a significant interruption in system operation is extremely low.

The proppant receiver 102 is a transportable system component that may be transported to and positioned as shown at a work site (e.g., near the well head/well bore of a fracking operation). The illustrated proppant receiver 102 defines a proppant unloading station 103, the first material conveyor 107 (e.g., a belt conveyor, at least a portion of which is inclined or upwardly sloped), and a proppant storage container 112 (or “surge bin”). The proppant receiver 102 is configured to receive deliveries of proppant at the work site. Typically, a proppant delivery truck (not shown in FIGS. 1A through 1J) is driven into the proppant unloading station 103 (via a ramp assembly, not shown in FIGS. 1A through 1J, but that may be attached to the edges of the proppant receiver's drive-over platform) and gravity dumps a delivery of proppant through a proppant inlet, which is defined by an opening in the platform at a proppant unloading station 103 of the proppant receiver 102. This bottom dump delivery of proppant, in a typical implementations, lands on the first material conveyor 107 after passing through the proppant inlet. The first material conveyor 107 moves the proppant from the proppant unloading station 103 at a first elevation (beneath the aperture or opening in the platform) to a second, higher elevation and to a discharge port on the first material conveyor 107.

The phrase “proppant unloading station” and reference number 103, refers to a space in the system 100 that is able to and does support and accommodate a proppant delivery truck that drives over an opening in the housing (typically, utilizing a ramp assembly to do so) to align a bottom dump opening in the truck with the opening in the housing. The sides of the housing that extend laterally across the system 100 (just ahead of the opening in the housing and just behind the opening in the housing) are strong enough to physically support the proppant delivery truck as it drives over the ramp and platform and moves into a proppant delivery position.

In a typical implementation, the first material conveyor 107 includes a housing with an internal belt conveyor. The internal belt conveyor, according to the illustrated implementation, includes include a first section that extends in a substantially horizontal manner from the proppant drop spot and a second section that extends in an inclined or upwardly-sloped manner from the distal end of the first section to a higher elevation than the proppant drop spot. The first material conveyor 107 is configured such that, during operation, proppant moves along the flat first section of the internal belt conveyor, up the upwardly-sloped section of the internal belt conveyor, and then off the distal end of the internal belt conveyor, falling through a discharge port of the first material conveyor 107.

The discharge port of the first material conveyor 107 is configured to discharge into the surge bin 112. The surge bin 112, therefore, is configured to receive proppant from the first material conveyor 107. In a typical implementation, the proppant may fall off a distal end of the upwardly-sloped section of the internal belt conveyor in the first material conveyor 107 and fall, under the influence of gravity, though the discharge port formed in the housing of the first material conveyor 107, and into the surge bin 112. The surge bin 112, in the illustrated implementation, is large and hollow and thereby defines an internal proppant storage space surrounded by a rigid container.

In one implementation, the surge bin 112 has a storage capacity of approximately 25 tons. In another implementation, the surge bin 112 has a storage capacity of approximately 80 tons. Other storage capacities (e.g., higher and lower) are possible as well. The surge bin 112 has an opening at or near the top of its housing that allows proppant conveyed by the first material conveyor 107 to fall into the surge bin 112. The surge bin 112 may be used for temporary proppant storage. In a typical implementation, as mentioned above, the surge bin 112 is configured to selectively discharge proppant (depending on the configuration of surge bin discharge valves) to one or more of the first bucket elevator 105a, the second bucket elevator 105b, and the second material conveyor 104. Typically discharge to any of these places happens via gravity. In this regard, chutes 116a, 116b respectively extend from a bottom portion of the surge bin 112 to a boot portion of a corresponding one of the bucket elevators 114a, 114b. Specifically, chute 116a extends from a bottom portion of the surge bin 112 at a first side of the surge bin 112 in a first direction to the boot portion of bucket elevator 114a, and chute 116b extends from a bottom portion of the surge bin 112 at a second side of the surge bin 112 in a second direction, opposite the first direction, to the boot portion of the bucket elevator 114b. Moreover, in a typical implementation, the flow passage 118 extends from a bottom portion of the surge bin 112 to an upward facing inlet of the second conveyor 104.

Each of the first and second bucket elevators 105a, 105b is configured to receive the proppant directed to it from the surge bin 112. The proppant arrives in a boot portion of the bucket elevator 105a, 105b. Each bucket elevator is configured to convey the proppant it receives from the boot portion of the bucket elevator to a higher elevation than the boot portion (e.g., near the top of the bucket elevator). In a typical implementation, each bucket elevator is configured to convey the proppant in a vertically upward direction from the boot portion of the bucket elevator and to discharge the proppant through a discharge port of the bucket elevator at or near the top of the bucket elevator. More specifically, in a typical implementation, each bucket elevator comprises a housing, an inlet defined by the housing that facilitates loading proppant into the bucket elevator, a boot portion at or near the bottom of the bucket elevator for receiving the proppant loaded into the bucket elevator, buckets or other conveyors to carry the proppant, a belt to carry the buckets, a means (e.g., a drive motor or engine) to drive the belt, an outlet defined by the housing that facilitates discharging the proppant at or near the top of the bucket elevator, and other accessories and supporting structures.

Each bucket elevator 105a, 105b in the illustrated implementation discharges through a valve 114a, 114b (e.g., a route valve) to a selected one of two associated and adjacent silos. For example, bucket elevator 105a in the illustrated implementation discharges to either silo 106a or silo 106b depending on the configuration of route valve 114a. Likewise, bucket elevator 105b in the illustrated implementation discharges to either silo 106c or silo 106d depending on the configuration of route valve 114b. In the illustrated implementation, silo 106a and silo 106b are positioned adjacent to and on opposite sides of bucket elevator 105a.

A first chute 122a extends in the illustrated implementation between the discharge end of the route valve 114a and silo 106a. A second chute 122b extends in the illustrated implementation between the discharge end of the route valve 114b and silo 106b. Each of these chutes accommodate proppant flow between route valve 114a and either the first silo 106a or the second silo 106b. Likewise, in the illustrated implementation, silo 106c and silo 106d are positioned adjacent to and on opposite sides of bucket elevator 105b. A third chute 122c extends in the illustrated implementation between the discharge end of the route valve 114b and silo 106c. A fourth chute 122d extends in the illustrated implementation between the discharge end of the route valve 114b and silo 106d. Each of the third and fourth chutes is configured to accommodate proppant flow between route valve 114b and either the third or fourth silos 106c, 106d, respectively.

Each route valve 114a, 114b can be any kind of valve that is able to selectively direct a flow of proppant toward a particular direction (e.g., toward one silo or another). In an exemplary implementation, each route valve 114a, 114b may be configured with a housing that defines an inlet and at least two outlets, and internal gates, which depending on its position, directs the flow of proppant to a selected one of the outlets. The route valves 114a, 114b may be operated in a variety of ways including, for example, via actuation by a pneumatic cylinder, electric linear actuator, spring-loaded manual operation, electric rotary actuator, hydraulic cylinder, etc.

Each silo is generally configured to receive proppant from a corresponding one of the bucket elevator discharges, via a corresponding one of the route valves and chute, and temporarily store such proppant. In the illustrated implementation, for example, silo 106a is configured to receive proppant from the discharge of bucket elevator 105a through route valve 114a and its chute, silo 106b is configured to receive proppant from the discharge of bucket elevator 105a through route valve 114a and its chute, silo 106c is configured to receive proppant from the discharge of bucket elevator 105b through route valve 114b and its chute, and silo 106d is configured to receive proppant from the discharge of bucket elevator 105b through route valve 114b and its chute. In a typical implementation, the proppant is delivered into each of the silos into the upper portion of the silo.

In a typical implementation, each silo is equipped with one or more internal level sensors to sense the level of proppant inside the silo. In some implementations, the one or more level sensors inside a silo provide signals that influence the position of a corresponding one of the route valves. More specifically, if a level sensor in a particular silo is producing a signal that indicates that the level of proppant inside the silo is above a predetermined level considered to be full, for example, then the system 100 may cause the corresponding route valve to reconfigure so as to direct subsequent proppant into the other silo connected to the route valve, assuming that other silos is not also full. In case the level sensors in both silos attached to a particular route valve are full, then the valve configuration at the bottom of the surge bin 112 may switch to direct proppant from the surge bin 112 to the other set of silos.

Each silo 106a-106d in the illustrated implementation has a discharge chute 124a-124d near a bottom of the silo. Each discharge chute 124a-124d extends from the silo towards the second conveyor 104. Moreover, each discharge chute 124a-124d terminates at, and dumps into, the second conveyor 104. Each silo discharge chute 124a-124d, which may have a valve to regulate flow through it, therefore, is configured to discharge proppant from a corresponding one of the silos 106a-106d to the second conveyor 104.

In a typical implementation, therefore, all silos 106a-106d are able to discharge into the second conveyor 104. In a typical implementation, the system 100 may normally feed proppant from the surge bin 112 into the second conveyor 104 and, if the proppant level in the surge bin 112 dips below a certain level (e.g., as sensed by one or more level sensors in the surge bin 112), the system 100 switches over to a selected one (or more) of the silos 106A-106d to begin supplying proppant into the second conveyor 104. In an exemplary implementation, silo selection may be made based on the level of proppant in the silos (based on weight measurements made by one or more load cells 222a-222d supporting the silos), with the silo containing the most amount of proppant being selected first, the silo containing the second most amount of proppant second, and so on. In another exemplary implementation, silo selection may be done according to some predetermined ordering of silos. Regardless of selection method, the first selected silo typically supplies proppant into the second conveyor 104 until the amount of proppant remaining in the selected silo drops below a predetermined amount (as measured by one or more load cells supporting the silo). Once the amount of proppant remaining in the selected silo drops below this predetermined amount, the system 100 would switch over to draw proppant from the next silo.

In a typical implementation, the load cell(s) supporting the silo may be operable to produce a signal indicating, for example, the presence of proppant at a particular level within the silo or a weight of the silo (including any proppant contained therein). The signal may be sent to a system controller. In response to receiving the signal, a computer-based processor within the controller, for example, may determine when a switch should be made (e.g., by comparing the weight signal from the load cell(s) to a predetermined value stored, e.g., in computer memory, that corresponds to a weight of the silo (plus proppant) when that silo should be considered effectively empty (or ready to be switched away from in favor of using a different silo). In an exemplary implementation, each load cell produces a signal between 0 volts and 5 volts-, where the voltage varies from low to high depending on whether the corresponding silo is empty or full or somewhere in between.

All this time, the system 100 (e.g., the controller in the system 100) may be monitoring the level of proppant in the surge bin 112 and once the surge bin 112 has a sufficient amount of proppant (e.g., as indicated by one or more level sensors in the surge bin 112), the controller may reconfigure the valves of the system 100 to provide proppant to the second conveyor 104 from the surge bin 112 (instead of from any of the silos). Moreover, once the surge bin 112 has a sufficient amount of proppant to supply to the second conveyor 104, the system 100 may then begin directing some amount of proppant from the surge bin 112 to one or more of the silos to replenish the proppant levels in those silos.

The surge bin 112 in the illustrated implementation is configured to discharge, typically via gravity, onto a belt of the second material conveyor 104. In some implementations, the second material conveyor 104 includes a belt conveyor that is able to be operated as a belt feeder, at least optionally. A belt feeder is a type of belt conveyor specifically designed for material flow control. In a typical implementation, the system 100 is primarily operable to meter proppant being delivered by the system 100 into the downstream process by controlling a selected one of the gate valves at the silo to open and close to control the flow of proppant into the second conveyor 104, whose belt may be run at a constant rate. In a typical implementation, the system 100 is further operable to meter proppant delivery by operating the second conveyor 104 as a belt feeder.

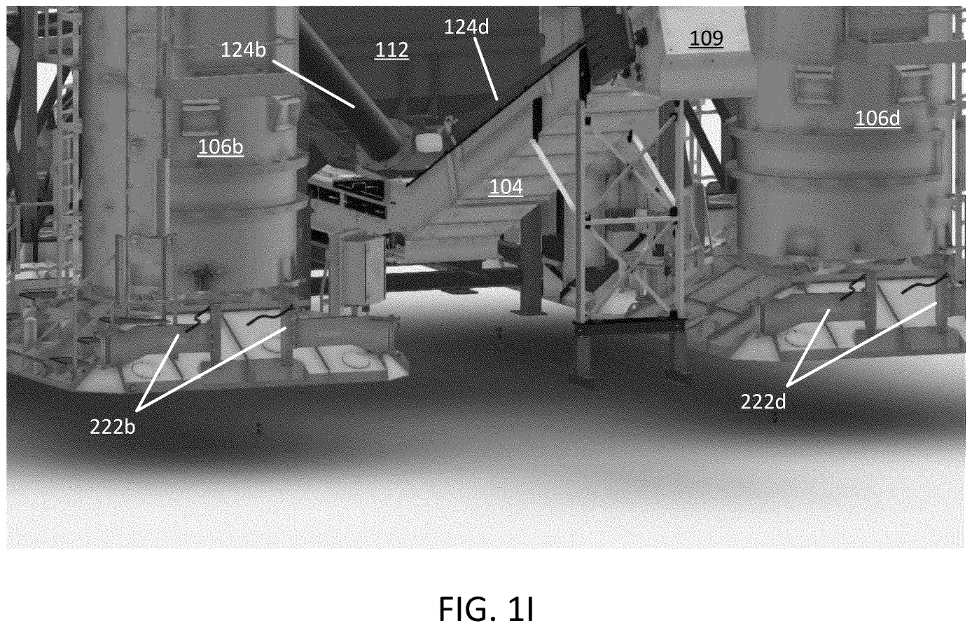

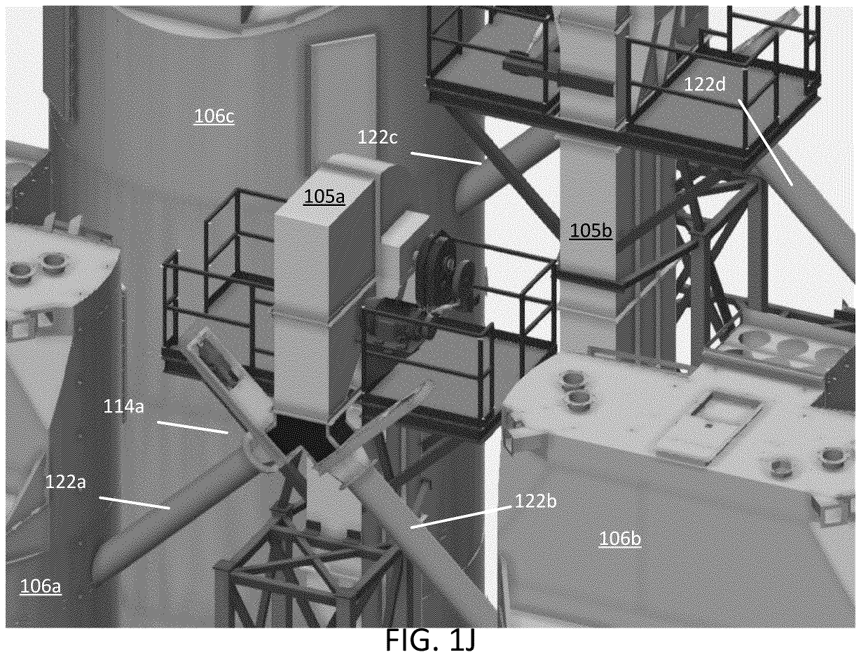

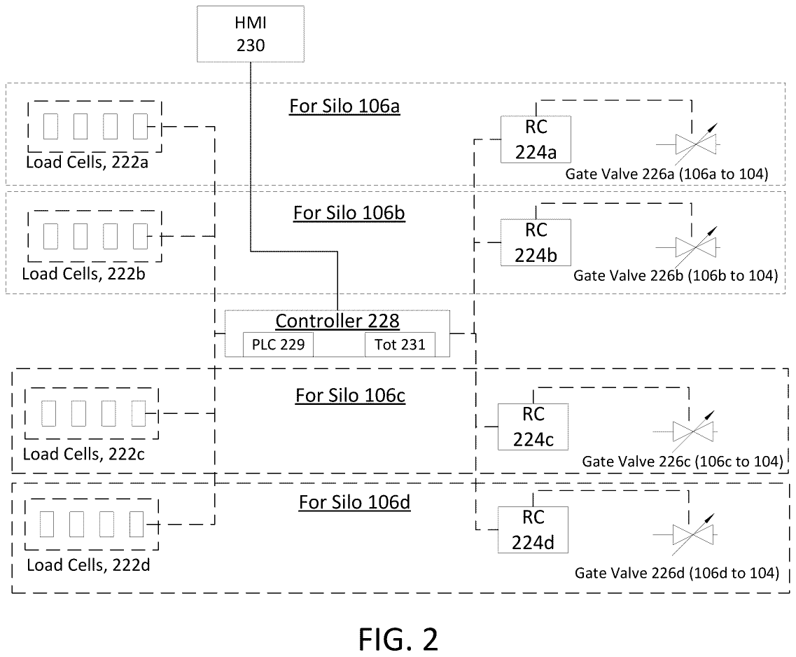

FIG. 2 is a schematic diagram representing an implementation of system components involved in controlling selected gate valves 220a-220d at the silos 106a-106d to open and close, automatically, to control the flow of proppant, for example, from a selected one or more of the silos into the second conveyor 104. The illustrated implementation shows various components associated with each of the silos 106a-106d. These components include, for each silo 106a-106d, load cells 222a-222d, a rate controller 224a-224d, and a gate valve 226d.

Each load cell 222a-222d is a force transducer that converts a force, such as compression or pressure, into a signal (e.g., an electrical signal). According to the illustrated implementation, each silo 106a-106d has four load cells. The four load cells on a given silo would be distributed across the bottom of that silo to support (and respond to) an entirety of the weight of the silo (plus any proppant contained within the silo). The number of load cells provided to support a particular silo may vary. For example, a smaller silo may be supported by only three load cells. A larger silo may require five or more load cells to support it. In an exemplary implementation, each load cell produces an electrical signal (e.g., an electrical current) with a value (e.g., amplitude) that varies between a first value (e.g., 0 volts) and a second value (e.g., 5 volts) depending on whether the silo is empty (which would result in the load cell producing an electrical signal having the first value) or full (which would result in the load cell producing an electrical signal having the second value). The signal produced by each load cell can vary between the first value and the second value, and may do so proportionally, if the level of the proppant in the silo is somewhere between empty and full. The load cells, therefore, produce real time signals that represent the real time level in the silo at any given time. Moreover, the real time signals vary as the level of proppant in the silo varies. More specifically, in a particular implementation, the amplitude of the electrical voltage increases as the proppant level (and, therefore, weight) increases. Conversely, in such an implementation, the amplitude of the electrical current decreases as the proppant level (and, therefore, weight) decreases.

The load cells 222a-222d from all of the silos in the illustrated system are connected to a controller 228, which may include, for example, a programmable logic controller (PLC) 229 and a totalizer 231. In a typical implementation, the PLC receives a variety of inputs (e.g., from sensors, such as the load cells, throughout the system 100, and from a human machine interface, HMI 230 where a human user enters operating instructions, e.g., feed rate and/or proppant type, etc. for the system 100) and controls various aspects of system 100 operation based on those inputs and based on code it is executing. In various implementations, the PLC performs these control functionalities by sending data and/or commands to various other system components (to control belt speeds, valve operation, etc.). The totalizer, in a typical implementation, determines a flow rate of proppant (e.g., out of a particular one of the silos) based on the load cell signals from the load cells for that silo. There are a variety of ways in which this sort of determination may be made. In one example, the signals from the multiple load cells for that silo may be averaged to produce an average load cell value. That average load cell value at different points in time, the change in average load cell value over a given interval of time, and data stored in memory that correlates this data to proppant flow rates provides an indication that the controller uses to control the rate controller 224a, 224b, 224c, or 224d for the gate valve 226a, 226b, 226c, or 226d on the associated silo.

Each rate controller 224a-224d in the illustrated implementation is an actuator for its corresponding gate valve 226a-226d. An actuator, in a typical implementation, is a component that produces a force, torque, or displacement, when an input signal (e.g., electrical, pneumatic, or hydraulic), which in this case, comes from the controller 228, is supplied to it. The actuator typically translates the input signal into mechanical energy, which, in the illustrated implementation, is applied to open, close, or make smaller adjustments to a corresponding one of the gate valves 226a-226d. In an exemplary implementation, the actuator may be implemented using a rate controller, such as rate controller model no. HI 4060, available from Hardy Process Solutions in San Diego, California.

In a typical implementation, a gate valve 226a-226d on a silo designated to supply proppant for the downstream process may be opened, closed, or otherwise controlled making smaller adjustments by the rate controller 224a-224 and in response to real time silo weight information being fed back from the load cells 222a-222d for that silo in real time. When the system 100 is operating in this manner, the second conveyor 104, which receives the proppant from the silo, typically operates at a constant speed, without regulating proppant flow at all. Thus, when the system is operating in this manner, proppant flow to the downstream process is controlled entirely by controlling the gate valve 226a-226d at the silo supplying the proppant.

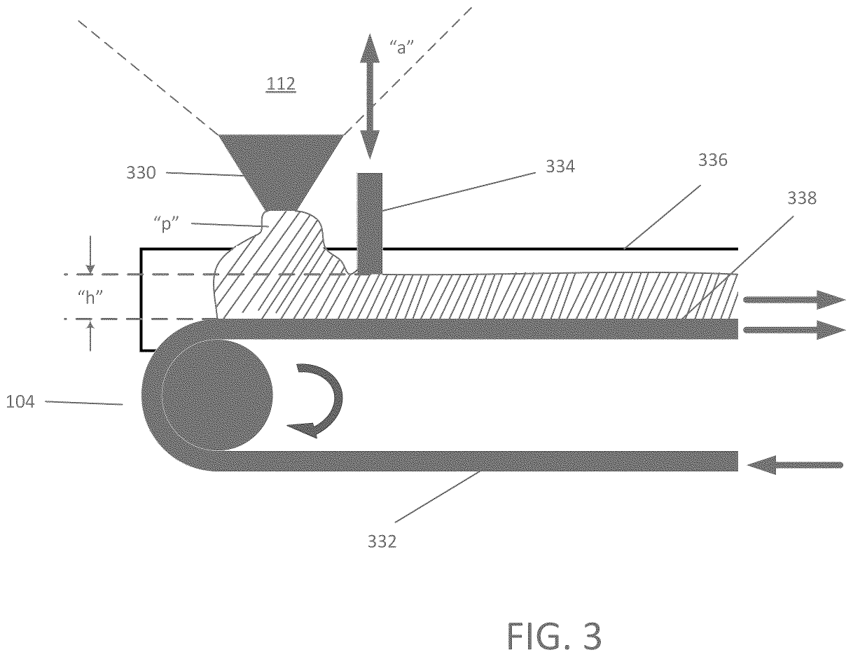

Alternatively, in some implementations, the system is able to operate with a silo valve wide open (or open to some constant, not varying) amount, and controlling proppant flow to the downstream process by operating the second conveyor 104 as a belt feeder. When operated as a belt feeder, the belt of the second conveyor 104 extracts material from one area (e.g., from a discharge hopper at the bottom of the surge bin 112 or from one of the silo discharge chutes) and ensures that downstream equipment (e.g., blender hopper and/or blender) receives proppant at an appropriate feed rate (e.g., some desired volume of proppant per time period). In a typical implementation, such as represented in the exemplary diagram in FIG. 3, the belt feeder configuration may include the discharge hopper 330 at the bottom of the surge bin 112, a belt 332 of the second material conveyor 104, a strike-off plate 334 above (and spaced apart from) the belt 334, and skirt boards 336 on both sides of the belt 332. In some implementations, a gate valve is provided to control proppant flow out of the discharge hopper 330 (and out of the silo discharges).

FIG. 3 shows only one of the skirt boards 336 (the one on the far side of the belt 332). In a typical implementation, there would be a similar skirt board (not shown in the figure), substantially parallel to the illustrated skirt board 336, and on the near side of the belt 332 (laterally across from skirt board 336). The strike-off plate 334 extends laterally across an entirety of the belt 332 and is above an upper surface 338 of the belt 332 by a height “h” that is adjustable, as indicated by arrow “a.” In a typical implementation, the strike-off plate extends entirely (or almost entirely, e.g., more than 85%, more than 90%, or more than 95%) across the lateral extent of the belt from one of the skirt boards (e.g., 336) to the other skirt board. The strike-off plate 334 in the illustrated implementation is shown as a separate physical item from the discharge hopper 330 of the surge bin 112. However, in various implementations, the strike-off plate 334 may be integrated into and consist of part of the discharge hopper 330 of the silo 112. In that case, the discharge hopper or a portion of the discharge hopper that includes the strike-off plate 334 may be configured to move up and down, like the strike-off plate 334 shown in FIG. 3. Moreover, in that case, the skirt boards (e.g., 336) would extend higher than the highest possible position of the strike-off plate or the portion of the discharge hopper acting as the strike-off plate.

During operation in this mode, the belt conveyor pulls proppant (“p”) out from under the discharge hopper 330 of the surge bin 112, while the strike-off plate 334 controls the height of the proppant that is allowed to advance as the belt 332 moves forward, and while skirt boards (e.g., 336) contain the proppant on the belt (i.e., prevent the proppant from falling off the sides of the belt). This type of belt feeder configuration essentially keeps the cross-sectional area of proppant “p” moving along the belt conveyor relatively constant, such that the volumetric proppant feed rate into the blender hopper can be controlled precisely by controlling and/or adjusting the speed of the belt conveyor in the second material conveyor 104 or the height of the strike-off plate 334 above the belt 332 or both.

In an exemplary implementation, if a downstream fracking process is calling for a certain rate of fracking fluid to be provided into the wellbore, the system 100 may be configured to automatically adjust the proppant flow rate at the second material conveyor 104 by controlling and/or adjusting the speed of the belt conveyor and/or the height of the strike-off plate 334 above the belt 332, accordingly. In this regard, a human operator may input into an HMI (e.g., HMI 230) (for system 100 or for the blender 110), for example, a desired rate of fracking fluid to be supplied into the well bore and/or a desired rate of proppant flow into the blender hopper. Moreover, If the desired rate of fracking fluid is entered, then the system controller, for example, may have computer memory that stores a table correlating proppant flow rates (into the blender hopper) to fracking fluid demand. In that case, the controller may receive a signal indicating a value representing a particular fracking fluid demand (e.g., the rate of fracking fluid needed to support fracking operations), and a processor in the controller may refer to the table in computer memory to determine the appropriate proppant flow rate (into the blender hopper) to support that demand. Then, if adjustments are needed (to achieve the proppant flow rate into the blender hopper), then the processor may cause the controller to send an actuating signal to cause the motor controller for the belt of the second material conveyor 104 to increase or decrease its speed and/or send an actuating signal to cause an actuator for the strike-off plate to increase or decrease the height of the strike-off plate 334 above the belt.

Operating in this mode, the second material conveyor 104 would be configured to receive proppant from the surge bin (or one of the silos discharge chutes) and to convey that proppant to a discharge of second material conveyor 104. The discharge of the second material conveyor 104 in the illustrated implementation is configured to discharge the proppant through an impact scale (not shown in FIGS. 1A through 1C), which is immediately downstream from and beneath the discharge of the second material conveyor 104, and then into a discharge hopper 109, which is immediately downstream of the impact scale. In a typical implementation, the impact scale may use readings from load cells (or other sensing elements) coupled to the impact scale, for example, to determine a quantity of proppant flowing into the blender hopper. This, in some implementations, may serve as a double check on the proppant delivery rate for which the belt feeder configuration, for example, is set to deliver. In some implementations, data from the impact scale may be transmitted and logged to a system data van, and may be checked, by the system controller, for example, against the belt speed and/or strike-off plate height settings to confirm that the weight of proppant passing through the impact scale corresponds appropriately to the proppant feed rate as set by the belt feeder characteristics (e.g., belt speed and/or strike-off plate height).

Referring again to FIGS. 1A-1J, the discharge hopper 109 may have any one of a variety of possible configurations. In one example, the discharge hopper 109 has a housing that defines an inlet and an outlet. The inlet may lie in an inlet plane, faces/open upward, and may be surrounded by an outwardly flanged surface that also lies in the inlet plane. The outlet may lie in an outlet plane, face downward, and may be surrounded by an outwardly flanged surface that also lies in the outlet plane. The inlet plane and the outlet plane may be disposed horizontally and parallel to one another. The discharge hopper 109 may include interior surfaces that define a flow path, along which the proppant may flow between the inlet and the outlet.

The blender hopper may be positioned beneath and configured to receive proppant from the belt feeder (or second conveyor 109) discharge, via the impact scale and the discharge hopper 109. The blender hopper receives the proppant and, in a typical implementation, includes means (e.g., augers, screw conveyors, etc.) to convey the proppant from the blender hopper into the blender. The blender, in a typical implementation, is configured to produce a blend that includes the proppant, and other components, for injection into the well bore to support racking operations. In some alternative implementations, the system 100 may be configured to deliver proppant directly into the blender, without the intermediate blender hopper.

In some implementations, the bucket elevators 105a, 105b and the silos 106a through 106d are suited to be transported to and from work sites (e.g., fracking wells). These maybe be transported (e.g., to a work site), in a lowered horizontal transport orientation, and then raised to a vertical working orientation at the work site. They may be transported to the work site by flat-bed trucks or trailers in a lowered horizontal transport orientation. The trailer may be maneuvered into position, and then the bucket elevator or silo is raised from the horizontal transport position to a vertical working position resting on the ground, and the trailer is moved away from the site.

In this regard, each bucket elevators (e.g., 105a) may be configured to be releasably attachable to a trailer. A raising bed may be pivotally attached at a rear end of the trailer and the bed may be attachable to the base of the bucket elevators 105a and to a lower section of the bucket elevator 105a pins engaging brackets, or by similar engagement mechanism, configured to engage the bucket elevator 105a to the raising bed of the trailer. An actuator may be mounted to the trailer and may be operative, when the raising bed of the trailer is attached to the bucket elevator 105a, to selectively move the bucket elevator 105a between a transport position where the bucket elevator 105a is supported on the trailer in a horizontal orientation, and a working position where the bucket elevator 105a is supported on the ground in a vertical orientation.

Support pads may be attached to an upper portion of the bucket elevator 105a and may be configured to rest on support posts of the trailer when the bucket elevator 105a is in the transport position. This arrangement may support the bucket elevator on the trailer. In an exemplary implementation, engagement mechanisms may be provided on one or more sides of the bucket elevator 105a. The trailer, therefore, may be releasably attachable to the bucket elevator 105a at whichever attachment locations are provided on the bucket elevator 105a. The bucket elevator 105a can thus be loaded on the trailer in a selected one of the multiple orientations of attachment.

The silos may be configured similarly, as shown and described, for example, in U.S. Pat. No. 10,300,828, entitled Vertically oriented transportable container with improved stability, owned by Quickthree Technology LLC, the applicant on the current filing, incorporated by reference in its entirety.

Other methods for easily coupling of the bucket elevators 105a, 105b and/or silos 106a through 106d to a trailer for transport are possible as well. In implementations where all the bucket elevators 105a, 105b and all the silos 106a through 106d are similarly configured to provide for easy coupling to a trailer for transport, delivery and set up, as well as removal, of the system 100 components is eased.

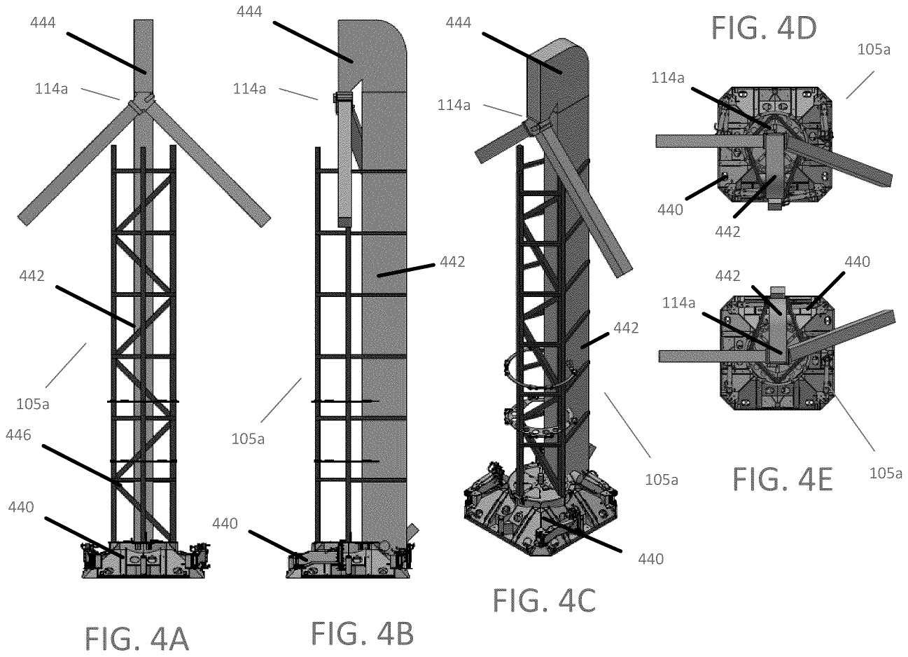

FIGS. 4A through 4E are schematic views showing an implementation of at least part of a bucket elevator 105a and a route valve 114a coupled to a discharge of the bucket elevator 105a. The illustrated bucket elevator has a base 440 and an elongate housing 442 that extends in an upward direction from the base 440. A discharge chute 444 is at the top of the housing 442 and includes a downward facing exit spout that faces and is coupled to the route valve 114a. A support frame 446 is provided around the outside of the housing 442. In the illustrated implementation, the support frame 446 is connected to the base 440 and to an external surface of the housing 442 at multiple places along the housing 442. The support frame 446 made be made of any one of a variety of different materials including, for example, metals and/or plastics. It is a generally rigid structure. The specific configuration of the support frame 446 can vary.

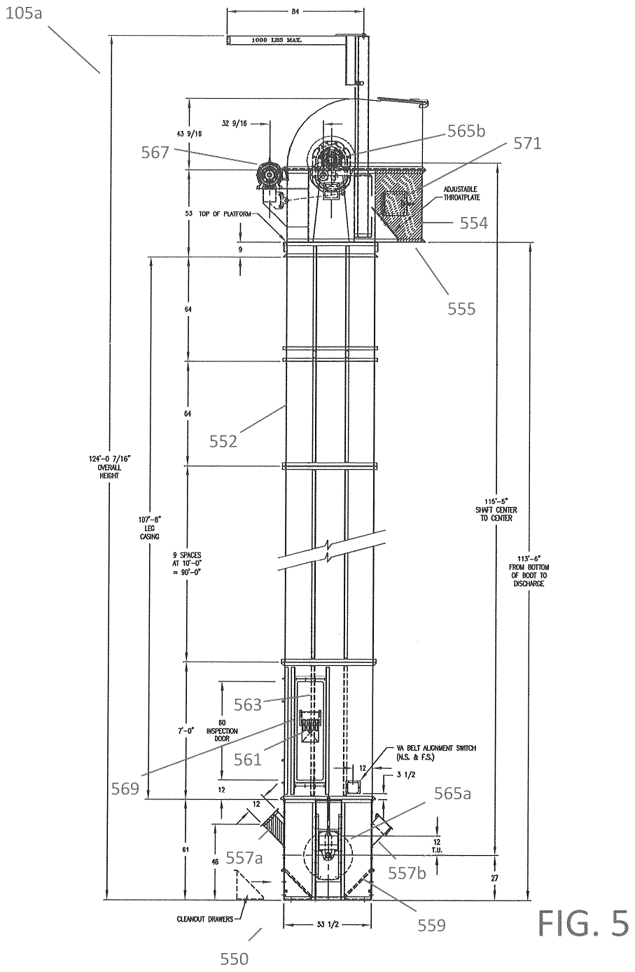

FIG. 5 is a side view showing an exemplary implementation of a bucket elevator (e.g., bucket elevator 105a in FIGS. 1A through 1J). The illustrated bucket elevator 505a has a base 550 and an elongate housing 552 that extends in an upward direction from the base 550. A discharge chute 554 is at the top of the housing 552 and includes a downward facing exit spout 555. Inlets 557a, 557b are defined by the housing 552, and extend out from a lower portion of the housing 552, to facilitate loading proppant into the bucket elevator 105a. A boot portion 559 of the bucket elevator 105a is provided at or near the bottom of the bucket elevator for receiving the proppant loaded into the bucket elevator. There are buckets (see, e.g., 561) inside the housing 552 that are configured to carry the proppant (e.g., from the boot portion 559 of the bucket elevator to the discharge chute 554 of the bucket elevator). The buckets (e.g., 561) are coupled to and typically evenly spaced on an endless belt 563 that rides along a pair of pulleys 565a, 565b. One of the pulleys 565a is near the bottom of the housing 552 and the other of the pulleys 565b is near the top of the housing 552. The pulley 565b near the top of the housing 552 is the drive pulley and is driven by a driving means (e.g., an electric motor 567 or other prime mover). There is an inspection door 569 in the bottom of the housing 552 and an access panel 571 in the discharge chute 554. FIG. 5 is marked up with dimensions and other annotations. These are exemplary only and should not be interpreted as limiting in any way.

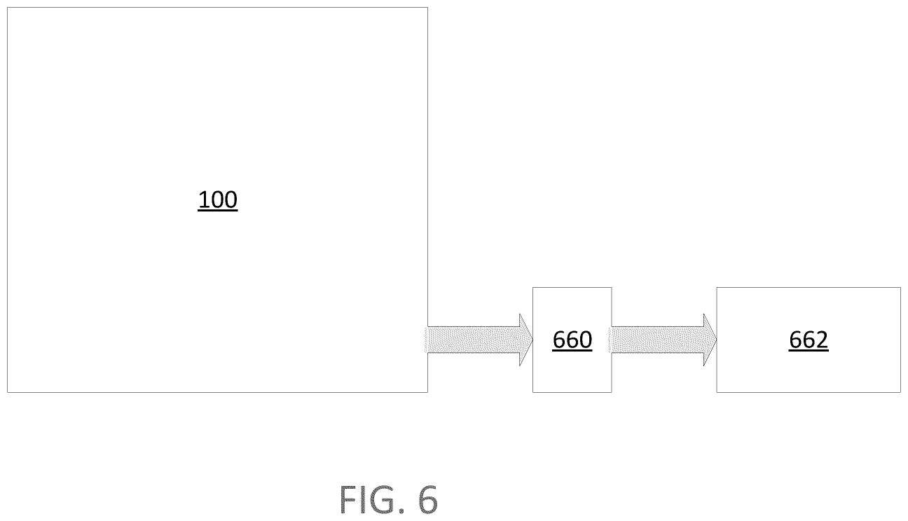

FIG. 6 is a schematic representation of the system 100 from FIG. 1 supplying proppant to a downstream process. The downstream process in the illustrated example includes a blending process that utilizes a blender hopper 660 and a blender 662 for a fracking application. In some implementations, the system 100 would discharge proppant directly to the blender 662 and the blender hopper 660 may be omitted.

A number of embodiments of the invention have been described. Nevertheless, it will be understood that various modifications may be made without departing from the spirit and scope of the invention.

For example, in a typical implementation, the rate proppant being delivered by the system to a downstream process is controlled by opening and closing a gate valve on a silo discharge that is feeding proppant, via gravity, onto the second material conveyor. The second material conveyor may be a belt conveyor and typically operates at a constant speed when the proppant delivery rate is being controlled by opening and closing the silo discharge valve. The position of the gate valve is based on a sequence of measurements that represent a flow rate for the proppant exiting the silo through the silo discharge as permitted by the silo discharge valve. The measurements, in an exemplary implementation, are made by one or more load cells arranged so as to collectively fully support the weight of the silo. Each load cell produces its weight measurements continuously or periodically over time. The individual weight measurements represent the portion of the weight of the silo plus any sand contained therein supported by the corresponding load cell at the time of the measurement. In a typical implementation, the weight measurement may be utilized to represent the total weight of the silo plus any sand contained therein. In this regard, for example, the weight measurements from the load cells that support that particular silo may be added together, averaged then multiplied by the number of load cells supporting that particular silo, or otherwise combined to produce a value that represents a real time value of weight for the silo plus any sand contained therein. This process of producing a value that represents the real time value of weight for the silo plus any sand contained therein may be repeated periodically or continuously to produce a set of values that show how, over time, the weight of the silo plus any proppant contained therein is changing. Data from, or based on, the changing weight measurements may be totalized to calculate the amount of proppant that has flowed out of the silo in a particular period of time. These totalized amounts may be calculated periodically or continuously. Each totalized amount may be compared to a desired amount of proppant flow, which may have been entered, for example, into an HMI of the system by a human system operator. Depending on the outcome of this comparison, a signal may be produced and sent to an actuator of the silo discharge valve causing the silo discharge valve, for example, to open more, close more. Otherwise, the position of the silo discharge valve may remain the same. The amount that the silo discharge valve opens or closes may depend on how big a discrepancy there is between the desired proppant flow rate and the calculated actual proppant flow rate, as determined from the load cell readings. In an exemplary implementation, the positional adjustment to the silo discharge valve is proportional to the adjustment signal sent to the actuator for the silo discharge valve. Moreover, the signal sent to the actuator for the silo discharge valve may be proportional to the calculated discrepancy between the actual proppant flow rate (as determined from the load cell readings) and the desired proppant flow rate (as entered into the HMI by a human system operator). In various implementations, the actual proppant flow rate may be determined using other types and arrangements of sensors (e.g., internal level sensors at different levels within the silo rather than external load sensors) and the processing of sensor information may be done in a different manner to produce a signal to cause the actuator to control the silo discharge valve in a manner to better align actual proppant flow rate with desired proppant flow rate. In all of such implementations, the proppant flow rate from the overall system may be controlled by controlling the valve position at a silo discharge based on a calculated actual proppant flow rate and/or weight measurements, for example, of the silo and any contained proppant.

The human machine interface (HMI) can be virtually any kind of machine that enables a human system operator to enter commands (e.g., about desired proppant flow rates, desired proppant type, etc.) to the system, which cause the system to respond accordingly. In various implementations, the HMI may include any one or more of a variety of different input/output devices including for example, input devices such as keyboard, touchscreen with graphical user interface, microphone, mouse, etc. and output devices, such as visual screen with graphical user interface, audio speaker, printer, etc.

As another example, the number and physical arrangement of the illustrated system components may vary. For example, in various implementations, there may be more or fewer silos, there may be more or fewer bucket elevators, there may be more diverter valves, and more or fewer route valves. In various implementations, the number of bucket elevators and/or silos on one side of the surge bin may be different than the number of bucket elevators and/or silos on the other side of the surge bin. Likewise, the number, specific placement of, and functionality of the level sensors, and other measuring devices may differ. The feed requirements may come to the controller, for example, in any number of ways including, for example, by a manually entered value at the downstream blending process.

The specific types of sensors, including the level sensors, can vary considerably. In certain implementations, at least one (and possibly as many as all) of the level sensors provided in the silos and/or surge bin may be a VEGAVIB™ 63 vibrating level switch with a tube extension for granular bulk solids, available from Vega Americas, Inc. of Mason Ohio. The VEGAVIB™ 63 vibrating level switch is a level switch for granular and coarse-grained bulk solids that is configured to detect minimum or maximum limit levels. The VEGAVIB™ 63 vibrating level switch operates on the vibration principle. More specifically, it is equipped with a vibrating element (e.g., a rod) that operates as a sensor element. The vibrating element is energized piezoelectrically and vibrates at its mechanical resonance frequency. When the vibrating element is immersed in proppant (or if the proppant level drops to uncover the vibrating element), the vibration frequency changes. This change is detected by an integrated electronics module for the vibrating level switch and converted into a switching command. The position of the switching point in a VEGAVIB™ 63 vibrating level switch is typically specified through the tube extension.

Overall system storage capacity can vary. In some implementations, the proppant storage capacity may be as much as 800 tons or more, including the surge bin and the silos.

The silos can be virtually any kind of silo. In a typical implementation, the silos are configured to deliver proppant (e.g., to the surge bin or elsewhere in the system) by gravity feed only. In some implementations, the silos may be SmartDepot™ silos, available from SmartSand, Inc. The SmartDepot™ silos utilize technology that facilitates their delivery and ease of installation, and ability to stand upright, as shown in the figures, at a worksite. In a typical implementation, the bucket elevators may utilize the same type of technology to facilitate their delivery and ease of installation, and ability to stand upright, as shown in the figures, at the worksite. In either case, trailers, such as the Quickstand™ trailer available from SmartSand, Inc., may be used to deliver and position, orient into a working configuration, the silos, and/or the bucket elevators with ease.

In some implementations, the bucket elevators may have some of the same basic structural components as the silos (e.g., the SmartDepot™ silos) that enable the silos to interact with and engage with a suitable delivery trailer, such as the aforementioned Quickstand™ trailer. More specifically, in an exemplary implementation, the base and elongate body of each bucket elevator may include the same basic structural features as the silos that enable it to engage with the Quickstand™ trailer (or other comparable trailers) as the silos. An example of the foregoing structural features, and a corresponding trailer, are described in U.S. Pat. No. 9,428,094, entitled Transport Apparatus for Elongate Objects, assigned to QuickThree Technology, LLC, and in U.S. Pat. No. 9,315,294, entitled Vertically Oriented Transportable Container with Improved Stability, also assigned to QuickThree Technology, LLC, each of which is incorporated by reference herein in its entirety.

In various implementations, there could be more than two silos (e.g., three or four or as many) per route valve, and each such route valve could be configured to deliver to any one of the multiple silos with each silo having a discharge chute back to the one and only one single surge bin. In one exemplary implementation, the system will include eight silos. In such implementations, the bucket elevators may be a bit higher, relative to the silos, than the bucket elevators described herein. In such implementations, there may be a diverter valve arrangement at the top end of each bucket elevator, configured to divert proppant flow from the discharge of that bucket elevator to any one or more of four different silos near the bucket elevator. Moreover, each of those four silos (on each side of the system 100) would be able to discharge proppant into the second conveyor. Other numbers of silos (including an unequal number of silos on the two sides of the system) may be used as well.

In various implementations, the system may be adopted to meter proppant to the downstream blending process with such precision that the proppant may be provided directly into the blender unit, bypassing (and eliminating the need for) a blender hopper between the system and the blender.

Each of the first and second material conveyors is configured with a first section, a second section, and (optionally) a third section. The first section is relatively flat and extends, substantially horizontally, beneath where the truck dumps its proppant delivery and beneath the surge bin. The second section is inclined relative to the first section and is configured to convey proppant, e.g., via conveyor belt, from the first section to a third section that is higher than the first section. At least the second section (and typically at least part of the other sections) is typically enclosed within a housing. The optional third section is at the top of the second section and is configured to deliver the proppant to a drop point, where the proppant drops off a distal end of the belt, typically, passing through a discharge opening in the housing at the upper end thereof.

The impact scale immediately downstream from and beneath a discharge of the belt feeder may produce data readings using load cell(s) (or other sensing elements), for example, to determine a quantity of proppant flowing into the blender or the blender hopper. Data from the impact scale may be transmitted and logged to a system data van and may be checked against delivery records showing how much proppant has been delivered, via truck, into the proppant receiver.

The proppant can be any kind of proppant. Typically, proppant is a solid material, such as sand, treated sand or man-made ceramic materials, designed to keep an induced hydraulic fracture open, during or following a fracturing treatment. It may be added to other substances to produce fracking fluid which may vary in composition depending on the type of fracturing used, and can be liquid-based, gel-based, foam-based, etc.

In various implementations, the mechanical conveyors may utilize various different types of conveying mechanisms. In a typical implementation, the mechanical conveyors utilize belts. In other configurations, however, one or both of the conveyors may utilize other types of mechanical conveying mechanisms, such as screw conveyors, bucket conveyors, pneumatic conveyors, etc.

The size, shape, and configuration, relative and absolute, of the system and its various components can vary considerably. Materials can vary as well.

A route valve, as referred to herein, can refer to any valve or combination of valves that are capable, either alone or collectively, to perform the functionalities attributed to the route valves, as described herein. In an exemplary implementation, a route valve may comprise or consists of one or more knife gates placed in the material stream. The knife gates can be closed to block the material stream or opened in any combination to route the material stream to one or more locations.

As mentioned herein, in certain implementations, the proppant unloading system 102 may be (or be included as part of) a SmartPath™ unloading system, available from Smart Sand, Inc., adapted as needed to include the features disclosed herein. Various aspects of the SmartPath™ unloading system, and variations thereof, are described in U.S. Patent Application Publication No. 2022/0017310, entitled Flow Control for Bottom Dump Pneumatic Material Handling, which is incorporated by reference herein in its entirety. Other implementations may be implemented differently.

In some implementations, one or more of the components described herein as being integrated into one overall assembly, may be physically separate from each other (and not physically integrated). For example, in some implementations, the drive over conveyor may be provided as a separate piece of equipment from the other system components. In those implementations, a mechanical conveyor of the proppant receiver would be provided to mechanically convey material from the drive over conveyor to the separate container. In general, any system component(s) provided on a separate base (e.g., not mounted on the same chassis as the other system components) would be operationally connected into the system (and to the other system components) as shown in the drawings and otherwise described herein to the other system components. In some implementations, more than one of the system components may be provided as a physically discrete component (and not mounted on the same chassis as the other system components).

Moreover, while this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are disclosed herein as occurring in a particular order, this should not be understood as requiring that such operations be performed in the particular order shown or in sequential order, or that all represented operations be performed, to achieve desirable results.

The systems described herein are material handling systems and the techniques described herein relate generally to material handling. This is suitable for handling proppant (e.g., sand, treated sand, or man-made ceramic materials) designed to keep induced hydraulic fractures open, during or following a fracturing treatment, but can be applied to handle any one of various other types of solid materials (e.g., any bulk powder or granular material; sand, grain, cement, powdered chemicals, salt, etc.)

The systems and techniques are useful at a worksite (e.g., one that includes one or more hydraulic fracturing wellheads). The worksite need not have actual wellheads in place though. Instead, a worksite could be a location where fracking is intended to take place, but where no wellheads are yet in place. The worksite could also be at a temporary storage location. The worksite could also be at a material processing site. The system could work for any bulk powder or granular material; sand, grain, salt, etc.

The systems described herein is easily portable. Portability, however, may be provided for in a variety of other ways than just those explicitly mentioned herein.

In some implementations, the system/process utilizes a Hardy HI4060 rate controller, which employs a sophisticated closed-loop control circuit to precisely regulate the dispensing of sand from a silo at a preprogrammed rate. The system may use load cells to continuously measure the sand's weight in real-time within the silos, providing immediate feedback on the actual flow rate. The rate controller may compare this measured flow rate to a predefined target rate in the PLC, which may be set by the operator through the HMI and identifies (and adjusts for) any deviations from the desired rate. This precise regulation may ensure that the dispensed sand closely adheres to the preprogrammed rate, optimizing efficiency, reducing waste, and maintaining process consistency. In such implementations, when a deviation is detected in the sand flow rate, the controller automatically calculates the necessary corrective actions and adjusts the output signal accordingly. These adjustments may control the actuator's position on a slide gate, increasing or decreasing the gate's opening to maintain the correct flow rate. The closed-loop feedback circuit, in such implementations, enables continuous monitoring and dynamic adjustments, ensuring that the dispensing process remains consistent and accurate, even when external factors such as material density, moisture, or other environmental conditions fluctuate. This sort of system is advantageous particularly in applications where consistent flow rates are essential, providing a reliable solution for maintaining accuracy in the sand dispensing process.

Other implementations are within the scope of the claims.

1. A system comprising:
a first material conveyor configured to receive a delivery of proppant and to convey the proppant to a discharge opening of the first material conveyor;
a surge bin configured to receive proppant from the discharge opening of the first material conveyor and to selectively discharge the proppant to a selected one of a plurality of surge bin discharge openings;
a second material conveyor configured to receive the proppant from a first one of the surge bin discharge openings and to convey the proppant to a discharge opening of the second material conveyor;
a first bucket elevator configured to receive the proppant from a second one of the surge bin discharge openings and to convey the proppant to a discharge of the first bucket elevator; and
a first silo configured to receive the proppant from the discharge of the first bucket elevator and to discharge the proppant through a first silo discharge to the second material conveyor.

2. The system of claim 1, further comprising:
a valve to control a flow of proppant through the first silo discharge; and
an actuator coupled to the valve and configured to control a position of the valve.

3. The system of claim 2, further comprising:
a plurality of load cells physically supporting an entirety of the first silo and any proppant contained within the first silo, wherein each of the loads cells is configured to produce a time varying signal indicating a weight of the first silo and any proppant contained within the first silo.

4. The system of claim 3, further comprising:
a human machine interface configured to receive input information from a human operator setting a desired proppant delivery rate for the system to deliver into a downstream process.

5. The system of claim 4, further comprising:
a controller configured to control the actuator based on the time varying signals from the plurality of load cells to maintain a flow of proppant from the first silo to the second material conveyor such that the system supplies proppant to the downstream process at the desired proppant delivery rate.

6. The system of claim 5, wherein the second material conveyor is a belt conveyor operating at a constant speed.

7. The system of claim 1, further comprising:
a second silo configured to receive the proppant from the discharge of the first bucket elevator and to discharge the proppant onto the second material conveyor; and
a first diverter valve coupled to the discharge of the first bucket elevator and configured to selectively divert proppant from the discharge of the first bucket elevator to either the first silo or the second silo.

8. The system of claim 7, further comprising:
a second bucket elevator configured to receive the proppant from a third one of the surge bin discharge openings and to convey the proppant to a discharge of the second bucket elevator;
a third silo configured to receive the proppant from the discharge of the second bucket elevator and to discharge the proppant onto the second material conveyor;
a fourth silo configured to receive the proppant from the discharge of the second bucket elevator and to discharge the proppant onto the second material conveyor; and
a second diverter valve coupled to the discharge of the second bucket elevator and configured to selectively divert proppant from the discharge of the second bucket elevator to either the third silo or the fourth silo.

9. The system of claim 8, wherein the first silo is configured to discharge the proppant onto the second material conveyor through a first silo discharge valve, wherein the second silo is configured to discharge the proppant onto the second material conveyor through a second silo discharge valve, wherein the third silo is configured to discharge the proppant onto the second material conveyor through a third silo discharge valve, and wherein the fourth silo is configured to discharge the proppant onto the second material conveyor through a fourth silo discharge valve.

10. The system of claim 9, further comprising:
a plurality of load cells beneath, and fully supporting a weight of, each respective one of the first silo, the second silo, the third silo, and the fourth silo;
a plurality of actuators, each actuator configured to control a respective one of the first silo discharge valve, the second silo discharge valve, the third silo discharge valve, and the fourth silo discharge valve.

11. The system of claim 10, wherein the downstream process is a blending process that utilizes a blender configured to blend the proppant supplied by the system to produce a fracking fluid.

12. The system of claim 11, where the blending process further utilizes a blender hopper configured to receive the proppant from a discharge of the second material conveyor.

13. (canceled)
